(19) United States
(12) Patent Application Publication
(10) Pub. No.: US 2023/0077630 A1
(43) Pub. Date: Mar. 16, 2023

(54) WATER-BASED COMPOSITION FOR BARRIER AND LAMINATED MATERIAL

(71) Applicant: ARAKAWA CHEMICAL INDUSTRIES, LTD., OSAKA (JP)

(72) Inventors: Keisuke Okada, Osaka (JP); Kaito Kuroda, Osaka (JP); Teruaki Sato, Osaka (JP)

(73) Assignee: ARAKAWA CHEMICAL INDUSTRIES, LTD., OSAKA (JP)

(21) Appl. No.: 17/893,178

(22) Filed: Aug. 23, 2022

(30) Foreign Application Priority Data
Aug. 26, 2021 (JP) 2021-138306

(51) Int. Cl. C09D 175/14; C09D 191/06; C09D 7/65

(52) U.S. Cl. CPC C09D 175/14; C09D 191/06; C09D 7/65

(57) ABSTRACT

A water-based composition for barrier containing a urethane resin (A) which is comprising a polyol (a1), a polyisocyanate (a2) and a chain extender (a3) as essential reaction components, and at least one wax (B) selected from the group consisting of a paraffin, a carnauba and an alkyl ketene dimer, and further a content ratio between the component (A) and the component (B) in terms of the non-volatile content weight is (A)/(B)=25/75 to 95/5.

### CROSS-REFERENCE TO RELATED APPLICATION

This application claims the priority benefit of Japan Application No. 2021-138306, filed on Aug. 26, 2021. The entirety of the above-mentioned patent application is hereby incorporated by reference herein and made a part of this specification.

### BACKGROUND

### Technical Field

The disclosure relates to a water-based composition for barrier and a laminated material.

### Description of Related Art

In applications such as packaging materials for foodstuffs and pharmaceuticals and electronic devices such as organic EL devices, a barrier property is required in terms of product quality. As the purpose and method of imparting a barrier property, for example, in applications of packaging materials, in order to prevent a gas such as water vapor or oxygen or a liquid such as water or an oil from entering from the outside to the inside of such a substrate or flowing out from the inside to the inside, a barrier composition is applied to the substrate and dried to form a coating of the composition. In addition, as a barrier composition, polyvinyl alcohol, polyvinylidene chloride and the like have been conventionally known (Patent Document 1 etc.).

However, polyvinyl alcohol is easily affected by humidity, and is unlikely to exhibit a water vapor barrier property particularly under a high temperature and high humidity. In addition, when polyvinylidene chloride is used, this is not preferable in terms of environment because harmful gases are generated during incineration.

In addition, as another technique, a multi-layer resin sheet in which a water vapor barrier resin layer made of an olefin resin is laminated on both surfaces of an oxygen barrier resin layer with an adhesive layer therebetween is also known (Patent Document 2). However, such a technique also has a problem of the amount of a petroleum-derived plastic used increasing.

As a method of reducing the amount of a petroleum-derived plastic used, application of a small amount of a diluted solution of the barrier composition to a substrate may be exemplified. In addition, in recent years, a water-based barrier composition has been desired in order to reduce VOC emission.

### PATENT DOCUMENTS

[Patent Document 1] Japanese Patent Laid-Open No. 1996-134242
[Patent Document 2] International Patent Laid-Open No. WO2017/221374

The disclosure provides a water-based composition for barrier that allows laminated material having excellent barrier properties to be provided.

The inventors conducted extensive studies and found that a water-based composition for barrier containing an each specific urethane resin and wax can address the above problem and completed the disclosure. That is, the disclosure relates to the following water-based composition for barrier and laminated material.

### SUMMARY

1. A water-based composition for barrier containing a urethane resin (A) which is comprising a polyol (a1), a polyisocyanate (a2) and a chain extender (a3) as essential reaction components, and at least one wax (B) selected from the group consisting of a paraffin, a carnauba and an alkyl ketene dimer, wherein a content ratio between the component (A) and the component (B) in terms of the non-volatile content weight is (A)/(B)=25/75 to 95/5.

2. The water-based composition for barrier according to 1, wherein the component (a1) contains a polyether polyol.

3. The water-based composition for barrier according to 1 or 2, wherein the component (a3) contains a dialkanol alkanoic acid.

4. The water-based composition for barrier according to any one of 1 to 3, wherein the reaction components further contain a hydroxy alkyl (meth)acrylic acid ester (a4).

5. The water-based composition for barrier according to any one of 1 to 4, wherein the reaction components further contain a (meth)acrylic acid alkyl ester having no hydroxyl group (a5).

6. The water-based composition for barrier according to any one of 1 to 5, further contains a rosin-based resin and/or a curing agent.

7. A laminated material having a coating layer of the water-based composition for barrier according to any one of 1 to 6 on at least one surface of a substrate.

### DESCRIPTION OF THE EMBODIMENTS

According to the water-based composition for barrier of the disclosure, a laminated material having excellent barrier is provided.

A water-based composition for barrier of the disclosure contains a specific urethane-based resin (A) (hereinafter referred to as a resin (A)), and a wax (B) (hereinafter referred to as a resin (B)).

The “barrier” in the present invention refers to a barrier for water vapor, oxygen, water, an oil or the like, and applications for which such a “barrier” is required include, for example, packaging materials and containers for foodstuffs, pharmaceuticals, miscellaneous goods and the like, building materials, precision instruments, electronic devices, and industrial materials.

The component (A) is a urethane resin containing a polyol (a1) (hereinafter referred to as a component (a1)), a polyisocyanate (a2) (hereinafter referred to as a component (a2)) and a chain extender (a3) (hereinafter referred to as a component (a3)) as essential reaction components.

The component (a1) is a compound having two or more hydroxy groups in the molecule, and examples thereof include low-molecular-weight glycols such as ethylene glycol, diethylene glycol, 1,2-propylene glycol and 1,4-butanediol, polyether polyol, poly (meth)acrylic polyol, and polycarbonate polyol. These may be used alone or two or more thereof may be used in combination. Among these, polyether polyol is preferable.

Examples of polyether polyols include polyethylene glycol, polypropylene glycol, polybutylene glycol, polytetramethylene glycol, polyhexamethylene glycol, polyheptamethylene glycol, polydecamethylene glycol, polyoxyethylene-polyoxypropylene glycol, polyoxytetramethylene-polyoxyethylene glycol, and polyoxytetramethylene-polyoxypropylene glycol. Here, a polyether polyol having a random structure or a block structure can be used.

Examples of commercially available products of polyether polyols include “Adeka Polyether P-400,” “Adeka Polyether G-400,” “Adeka Polyether T-400,” “Adeka Polyether AM-302,” “Adeka Polyether P1000,” and “Adeka Polyether P2000” (all are commercially available from ADEKA); “Polyethylene glycol #1,540” (commercially available from Nacalai Tesque, Inc.); “Dipropylene glycol,” and “Polypropylene glycol 400” (all are commercially available from Junsei Chemical Co., Ltd.); “PEG #200,” “PEG #300,” “PEG #400,” “PEG #600,” “PEG #1000,” “PEG #1500,” “PEG #2000,” “PEG #4000,” “Uniol D-200,” “Uniol D-700,” “Uniol D-1000,” “Uniol D-1200,” “Uniol D-2000,” “Uniol D-4000,” “Uniol PB-500,” “Uniol PB-700,” “Uniol PB-1000,” “Uniol PB-2000,” “Polycerin DC-1100,” “Polycerin DC-1800E,” “Polycerin DC-3000E,” “Polycerin DCB-1000,” “Polycerin DCB-2000,” and “Polycerin DCB-4000” (all are commercially available from NOF Corporation).

Examples of components (a2) include aliphatic diisocyanates such as methylene diisocyanate, butane-1,4-diisocyanate, hexamethylene diisocyanate, 2,2,4-trimethylhexamethylene diisocyanate, 2,4,4-trimethylhexamethylene diisocyanate, and a dimer diisocyanate in which a carboxyl group of a dimer acid is replaced with an isocyanurate group;

alicyclic diisocyanates such as cyclohexane-1,4-diisocyanate, isophorone diisocyanate, dicyclohexylmethane-4,4′-diisocyanate, 1,3-di(isocyanate methyl)cyclohexane, and methylcyclohexane diisocyanate;
aromatic diisocyanates such as 4,4′-diphenylmethane diisocyanate, 4,4′-diphenyldimethylmethane diisocyanate, 4,4′-diphenyltetramethylmethane diisocyanate, 1,4-phenylene diisocyanate, tolylene diisocyanate, xylylene diisocyanate, m-tetramethyl xylylene diisocyanate, 1,5-naphthalene diisocyanate, 4,4′-dibenzyl diisocyanate, and 1,3-phenylene diisocyanate; and
amino acid diisocyanates such as lysine diisocyanate. These may be used alone or two or more thereof may be used in combination. In addition, regarding the component (a2), these isocyanurate components, adduct components or biuret components may be used.

The ratio of the component (a1) and the component (a2) used is usually a ratio (NCO₍ₐ₂₎/OH₍ₐ₁₎ of the number of moles (NCO₍ₐ₂₎) of the isocyanate group of the component (a2) and the number of moles (OH₍ₐ₁₎) of the hydroxy group of the component (a1) is preferably about 1.1/1 to 8/1.

The component (a3) is a chain extender.

Examples of components (a3) include diamines such as ethylenediamine, propylenediamine, hexamethylenediamine, isophorone diamine, dimer diamine, dicyclohexylmethane-4,4′-diamine, 2-hydroxyethyl ethylenediamine, 2-hydroxyethyl propylenediamine, di-2-hydroxyethylethylenediamine, di-2-hydroxyethylpropylenediamine, 2-hydroxypropyl ethylenediamine, and di-2-hydroxypropyl ethylenediamine;

triamines such as diethylenetriamine, dipropylenetriamine, and diethylenetriamine;
tetramines such as triethylenetetramine and tripropylene tetramine;
N-alkyldialkanolamines such as N-methyldiethanolamine, N-ethyldiethanolamine, N-propyldiethanolamine, N-isopropyldiethanolamine, N-butyldiethanolamine, N-isobutyldiethanolamine, N-oleyldiethanolamine, N-stearyldiethanolamine, N-methyldiisopropanolamine, N-ethyldiisopropanolamine, N-propyldiisopropanolamine, and N-butyldiisopropanolamine;
hydrazine or its hydrazine derivatives (adipic acid hydrazine, etc.);
dialkanol alkanoic acids such as glyceric acid, dioxymaleic acid, dioxyfumaric acid, dimethylol acetic acid, dimethylol propionic acid, dimethylol butanoic acid, dimethylol pentanoic acid, and dimethylol caproic acid; and aromatic hydroxycarboxylic acids such as 4,4-di(hydroxyphenyl)butanoic acid,
4,4-di(hydroxyphenyl)pentanoic acid, and 2,6-dioxybenzoic acid. These may be used alone or two or more thereof may be used in combination. Among these, a dialkanol alkanoic acid is preferable because the produced polymer is easily dissolved or dispersed in water.

Here, a quaternizing salt may be used as the dialkanolamine. The quaternizing salt is a component obtained by reacting the dialkanolamine with a quaternizing agent, and examples of quaternizing agents include inorganic acids such as hydrochloric acid, sulfuric acid, and phosphoric acid; organic acids such as dimethyl sulfate, acetic acid, and propionic acid; and organic halogen compounds such as methyl chloride, benzyl chloride, and epichlorohydrin.

In addition, carboxyl groups of the dialkanol alkanoic acid and the aromatic hydroxycarboxylic acid may be neutralized with a neutralizing agent.

Examples of neutralizing agents include alkali metal hydroxides such as sodium hydroxide and potassium hydroxide; ammonia; and organic amines such as trimethylamine, triethylamine, triethanolamine, triisopropanolamine, N,N-dimethylethanolamine, and N,N-diethylethanolamine. These may be used alone or two or more thereof may be used in combination.

The amount of the component (a3) used with respect to 100 weight % of reaction components constituting the resin (A) is usually 1 to 30 weight % and preferably 3 to 20 weight %.

The resin (A) of the disclosure may contain a hydroxy alkyl (meth)acrylic acid ester (a4) (hereinafter referred to as a component (a4)) as a reaction component.

Examples of components (a4) include 2-hydroxyethyl (meth)acrylate, 2-hydroxy n-propyl (meth)acrylate, 3-hydroxy n-propyl (meth)acrylate, 3-hydroxy n-butyl (meth)acrylate, 4-hydroxy n-butyl (meth)acrylate, and 6-hydroxy n-hexyl (meth)acrylate. These may be used alone or two or more thereof may be used in combination. Among these, in consideration of excellent reactivity, one having a hydroxyalkyl group having 2 to 3 carbon atoms is preferable, and more preferably 2-hydroxy ethyl (meth)acrylate, 2-hydroxy propyl (meth)acrylate.

The amount of the component (a4) used with respect to 100 weight % of reaction components constituting the resin (A) is usually 10 weight % or less and preferably 0.1 weight % to 5 weight %.

The resin (A) of the disclosure may further contain a (meth)acrylic acid alkyl ester having no hydroxyl group (a5) (hereinafter referred to as a component (a5)) as a reaction component.

Examples of components (a5) include methyl (meth)acrylate, ethyl (meth)acrylate, n-propyl (meth)acrylate, isopropyl (meth)acrylate, n-butyl (meth)acrylate, isobutyl (meth)acrylate, s-butyl (meth)acrylate, t-butyl (meth)acrylate, n-pentyl (meth)acrylate, cyclopentyll (meth)acrylate, n-hexyl (meth)acrylate, cyclohexyl (meth)acrylate, 2-ethylhexyl (meth)acrylate, n-octyl (meth)acrylate, isooctyl (meth)acrylate, n-decyl (meth)acrylate, isobornyl (meth)acrylate, isodecyl (meth)acrylate, lauryl (meth)acrylate, myristyl (meth)acrylate, isomyristyl (meth)acrylate, palmityl (meth)acrylate, stearyl (meth)acrylate, and isostearyl (meth)acrylate. These may be used alone or two or more thereof may be used in combination. Among these, in order to improve the barrier property, one having an alkyl group having 12 to 18 carbon atoms is preferable, and more preferably lauryl (meth)acrylate, myristyl (meth)acrylate, palmityl (meth)acrylate, stearyl (meth)acrylate.

The amount of the component (a5) used with respect to 100 weight % of reaction components constituting the resin (A) is usually 50 weight % or less and preferably 10˜40 weight %.

The reaction components may further contain a chain extension inhibitor (a6) (hereinafter referred to as a component (a6)). Examples of components (a6) include monoalcohols such as methanol, ethanol, n-propyl alcohol, isopropyl alcohol, n-butyl alcohol, and isobutyl alcohol; monoamines such as ethylamine, n-propylamine, diethylamine, di n-propylamine, and di n-butylamine; and alkanol monoamines such as monoethanolamine and diethanolamine. These may be used alone or two or more thereof may be used in combination.

The amount of the component (a6) used with respect to 100 weight % of reaction components constituting the resin (A) is usually 5 weight % or less and preferably 3 weight % or less.

The resin (A) is obtained by, for example, reacting the component (a1) and the component (a2) to produce a urethane prepolymer and then reacting the urethane prepolymer and the component (a3), and as necessary, the components (a4) to (a6).

Regarding the reaction conditions in the process of obtaining a urethane prepolymer, the temperature is usually about 40° C. to 150° C. and preferably about 60° C. to 100° C. In addition, the time is usually about 1 to 20 hours and preferably about 1 to 10 hours. Next, regarding the conditions when the urethane prepolymer is reacted with the component (a3), and as necessary, the components (a4) to (a6), the temperature is usually about 20 to 100° C. and preferably about 30° C. to 80° C. In addition, the time is usually about 1 to 10 hours and preferably about 1 to 5 hours. Here, the mixing method and mixing order of respective components are not particularly limited.

These resins (A) may be produced in the absence of a solvent or in the presence of a solvent.

Examples of solvents include aromatic hydrocarbons such as benzene, toluene, ethylbenzene, n-propylbenzene, t-butylbenzene, o-xylene, m-xylene, p-xylene, tetralin, decalin, and aromatic naphtha; aliphatic hydrocarbons such as n-hexane, n-heptane, n-octane, isooctane, and n-decane; alicyclic hydrocarbons such as cyclohexane; esters such as ethyl acetate, n-butyl acetate, n-amyl acetate, 2-hydroxyethyl acetate, 2-butoxyethyl acetate, 3-methoxybutyl acetate, and methyl benzoate; ketones such as acetone, methyl ethyl ketone, methyl isobutyl ketone, isophorone, cyclohexanone, and methylcyclohexanone; glycol ethers such as ethylene glycol monomethyl ether, ethylene glycol monoethyl ether, ethylene glycol monobutyl ether, diethylene glycol monomethyl ether, diethylene glycol monoethyl ether, and diethylene glycol monobutyl ether; alcohols such as methanol, ethanol, n-propanol, isopropanol, n-butanol, isobutanol, s-butanol, and t-butanol; amides such as N,N-dimethylformamide and N,N-dimethylacetamide; amines such as N-methylpyrrolidone; water such as ion-exchanged water, purified water, tap water, soft water, hard water, and industrial water; and dimethyl sulfoxide. These may be used alone or two or more thereof may be used in combination. In addition, after the reaction is completed, the solvent may be distilled off under a reduced pressure or the like.

The amount of the solvent used is preferably adjusted so that the reaction concentration is 10 weight % or more.

In addition, in the above reaction, the component (B) to be described below may be added.

The resin (A) may further contain a pigment, a water retention agent, an antifoaming agent, a preservative, a leveling agent, a colorant, an anti-blocking agent, an antioxidant, a UV absorber, a thickener, a dispersant, and a filler.

The weight-average molecular weight of the obtained resin (A) is 5000 to 2000000. Here, the weight-average molecular weight is a value measured by a gel permeation chromatography method (GPC method) using polystyrene as a standard substance.

In addition, the viscosity of the solution of the resin (A) having a non-volatile content concentration of 35 weight % at a temperature of 25° C. is usually 5 to 20,000 mPaxs and preferably 10 to 10,000 mPaxs. Here, “viscosity” is a value measured by a B-type viscometer.

The component (B) is at least one wax selected from the group consisting of a paraffin, a carnauba and an alkyl ketene dimer, and is a component that imparts excellent barrier properties. Here, the alkyl ketene dimer is abbreviated as “AKD.” In addition, in the following, the wax of the component (B) may be referred to as a paraffin-based wax, a carnauba-based wax, or an AKD-based wax.

A paraffin is obtained by distilling crude oil under a reduced pressure and separating and purifying hydrocarbons with good crystallinity from the obtained distillate, and is mainly composed of linear hydrocarbon (normal paraffin).

Regarding the physical properties of the paraffin, for example, the melting point is preferably 45° C. to 80° C. and more preferably 55° C. to 80° C.

In the disclosure, the paraffin that has been made into an aqueous emulsion using a dispersant is preferably used. Examples of dispersants include nonionic surfactants, cationic surfactants, anionic surfactants and the like described in Japanese Patent Laid-Open No. 2013-237941.

Commercially available solid products of paraffin include, for example, “paraffin 115,” “paraffin 120,” “paraffin 125, “paraffin 130,” “paraffin 135,” “paraffin 140,” “paraffin 145,” “paraffin 150,” “paraffin 155,” and “HNP-51” (all are commercially available from Nippon Seiro Co., Ltd.). In addition, examples of aqueous emulsions include “Sizepine W-116H” (commercially available from Arakawa Chemical Industries, Ltd.). These may be used alone or two or more thereof may be used in combination.

A carnauba wax is collected from palm trees of the palm family, and its wax is called carnauba wax.

The carnauba-based wax is a naturally derived wax, and contains a wax ester as a main component, and also contains free fatty acids, free alcohols and hydrocarbons.

Regarding the physical properties of the carnauba, for example, the melting point is preferably 60° C. to 110° C. and more preferably 80° C. to 90° C. And the acid value is preferably 10 mgKOH/g or less.

Commercially available solid and/or liquid products of carnauba wax include, for example, “Selosol 524”(Chukyo Yushi Co., Ltd.), “EMUSTAR-0413”(Nippon Seiro Co., Ltd.), “Carnauba Wax Type 1 Flake,” “Carnauba Wax Type 1 Powder,” “Carnauba Wax Type 2 Flake,” “Carnauba Wax Type 2 Powder,” “Carnauba Wax Type 3 Flake,” “Carnauba Wax Type 3 Powder”(all are commercially available from Toyo Chem Co., Ltd.).

Examples of AKD include those represented by the following General Formula (1) (R¹ and R² each independently represent an alkyl group or an alkenyl group, and may be the same as or different from each other).

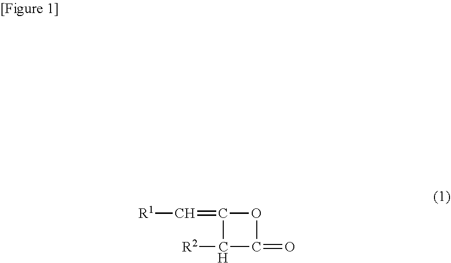

Examples of the alkyl group include a butyl group, a pentyl group, a hexyl group, a heptyl group, an octyl group, a nonyl group, a decyl group, an undecyl group, a dodecyl group, a tetradecyl group, a hexadecyl group, an octadecyl group, an eicosyl group, a docosyl group and a tetracosyl group, a hexacosyl group, an octacosyl group, a triacontyl group, a dotriacontyl group and the like. These may be branched.

Examples of the alkenyl group include a butenyl group, a pentenyl group, a hexenyl group, a heptenyl group, an octenyl group, a nonenyl group, a decenyl group, an undecenyl group, a dodecenyl group, a tetradecenyl group, a hexadecenyl group, an octadecenyl group, an eicosenyl group, a docosenyl group and a tetracosenyl group, a hexacosenyl group, an octacosenyl group, a triaconenyl group, a dotoriacontenyl group and the like. These may be branched.

These AKD may be used alone or two or more thereof may be used in combination. Among these, in order to improve obstacle performance, one in which R¹ and R² each independently represent an alkyl group or alkenyl group having 14 to 24 carbon atoms in General Formula (1) is preferable, and one in which R¹ and R² each independently represent an alkyl group having 14 to 24 carbon atoms, that is, a tetradecyl group (carbon number: 14), a hexadecyl group (carbon number: 16), an octadecyl group (carbon number: 18), an eicosyl group (carbon number: 20), a docosyl group (carbon number: 22), or a tetracosyl group (carbon number: 24) is more preferable.

In the present invention, it is preferable to use AKD which is made into a water-based emulsion using a known emulsifier. Regarding the emulsifier used in the production of the water-based emulsion and the method of producing the same, those described in, for example, Japanese Patent Laid-Open No. H2-19592, Japanese Patent Laid-Open No. H2-293493, and Japanese Patent Laid-Open No. 2012-211422 may be exemplified.

Commercially available solid products of carnauba wax include, for example, “Sizepine K-287,” “Sizepine K-903-20,” “Sizepine K-931,” “Sizepine K-924”(all are commercially available from Arakawa Chemical Industries, Ltd.), “AD1602,” “AD1606,” “AD1608,” “AD1612,” “AD1614,” “AD1638,” “AD1640,” “SE2360,” “SE2 380”(all are commercially available from Seiko PMC Co., Ltd.), “KDG series,” “SAK series”(all are commercially available from Toho Chemical Industries Co., Ltd.).

The component (B) may further contain a pigment, a water retention agent, an antifoaming agent, a preservative, a leveling agent, a colorant, an anti-blocking agent, an antioxidant, a UV absorber, a thickener, a dispersant, and a filler.

The content ratio between the component (A) and the component (B) in terms of the non-volatile content weight is preferably (A)/(B)=25/75 to 95/5. When the content ratio is within this range, a coating layer of the water-based composition for barrier exhibits excellent barrier properties. From the same viewpoint, the content ratio is preferably (A)/(B)=30/70 to 90/10, and more preferably (A)/(B)=50/50 to 90/10.

The water-based composition for barrier of the disclosure is obtained by mixing the component (A) and the component (B), and as necessary, water. Regarding the mixing conditions, for example, the temperature is 10° C. to 90° C. (preferably 20° C. to 80° C.). In addition, the mixing order, mixing method, and mixing time of respective components are not particularly limited.

The water-based composition for barrier of the disclosure may further contain additives such as a rosin resin such as a gum rosin, a wood rosin, a tall oil rosin, a saponified rosin, a hydrogenated rosin, a fumalized rosin, maleic rosin, rosin ester; a non-rosin resin such as acrylic resin, styrene-butadiene resin, polyester resin, modified polyolefin resin, petrolium resin, polyvinyl alcohol; a curing agent such as carbodiimide, polyisocyanate, aziridine, melamine; a pigment, a water retention agent, an antifoaming agent, an antioxidant, a preservative, a leveling agent, and a colorant. These additives may be used alone or two or more thereof may be used in combination. And the additive content with respect to the total of 100 parts by weight of the component (A) and the component (B) is preferably 20 weight parts or less, and more preferably 10 weight parts or less because of avoidance of inhibition of the barrier property.

Regarding the physical properties of the obtained water-based composition for barrier, the non-volatile content concentration is usually 5 to 50 weight % and preferably 10 to 40 weight %.

In addition, the viscosity of the solution of the water-based composition for barrier having a non-volatile content concentration of 30 weight % at a temperature of 25° C. is usually 10 to 1000 mPa·s and preferably 20 to 500 mPa·s.

A laminated material having a coating layer of the water-based composition for barrier on at least one surface of a substrate.

The laminate is obtained by, for example, a method of applying a water-based composition for a barrier to at least one surface of the substrate and drying it.

Examples of substrates include base paper, a support film, a metal plate and the like.

Examples of base paper include those made from chemical pulps such as leaf bleached kraft pulp (LBKP) and needle bleached kraft pulp (NBKP); mechanical pulps such as ground pulp (GP), refiner ground pulp (RGP), and thermomechanical pulp (TMP); DIP, mercerized pulp, recycled pulp and the like by various paper machines, and more specific examples thereof include bleached kraft paper, unbleached kraft paper, woodfree paper, medium quality paper, finely coated paper, coated paper, processed base paper, paperboard, white paperboard, liner, semi-glassine paper, glassine paper, and parchment paper. In addition, the pulp containing pH adjusting agents such as aluminum sulfate, sulfuric acid and sodium hydroxide; papermaking chemicals such as a sizing agent, paper strengthening agents (for example, starch and polyacrylamide), and a wet paper strengthening agent; and fillers such as talc, clay, kaolin, titanium dioxide, and calcium carbonate may be used.

Examples of support films include polyimide resins such as a polyimide and a polyimide-silica hybrid; polyolefin resins such as polyethylene, polypropylene, and a cycloolefin polymer; polyester resins such as polyethylene terephthalate, polyethylene naphthalate, polybutylene succinate, polybutylene succinate adipate, polybutylene adipate terephthalate, polyhydroxyalkanoate, and polylactic acid; acrylic resins such as polymethyl methacrylate; fluorine-based resins such as polytetrafluoroethylene (PTFE), perfluoroalkoxy alkane (PFA), and polyvinylidene fluoride (PVDF); aromatic polyester resins obtained from ethylene terephthalate, phenol, phthalic acid, hydroxynaphthoic acid or the like and p-hydroxybenzoic acid (so-called liquid crystal polymer; “Vecstar,” or the like commercially available from Kuraray Co., Ltd.); cellulose resins such as acetyl cellulose and cellophane; and polystyrene resins, polycarbonate resins, acrylonitrile-butadiene-styrene resins and the like. These may be used alone or two or more thereof may be used in combination.

Examples of metal plates include aluminum-based metal plates such as an aluminum plate, an aluminum-plated steel plate, and an Al—Si alloy-plated steel plate; zinc-based metal plates such as a zinc-plated steel plate, a Zn—Fe alloy-plated steel plate, a Zn—Co alloy-plated steel plate, a Zn—Co—Cr alloy-plated steel plate, a Zn—Cr—Ni alloy-plated steel plate, a Zn—Cr—Fe alloy-plated steel plate, a Zn—Al alloy-plated steel plate, a Zn—Mg alloy-plated steel plate, a Zn—Al—Mg alloy-plated steel plate, and a Zn—Ni alloy-plated steel plate; a copper plate, a steel plate, a titanium plate, a stainless steel plate, a tin plate, a nickel-plated steel plate, a chromium-plated steel plate, and a phosphate-treated steel plate. These may be used alone or two or more thereof may be used in combination.

In addition, as the base paper, the support film or the metal plate, one in which an anchor layer, a filling layer, a water resistant layer, an oil resistant layer, an antistatic layer or the like is additionally provided on one surface or both surfaces thereof may be used.

Examples of a method of applying a water-based composition for barrier include methods using a bar coater, a knife coater, a size press coater, a roll coater, a reverse roll coater, a curtain coater, a gravure coater, an air knife coater, a calender, a gate roll coater, a blade coater, a 2-roll size press, rod metering and the like. In addition, the coating amount of the coating liquid (in terms of the non-volatile content) is not particularly limited, and is usually about 0.1 to 10 g/m² and preferably about 1 to 6 g/m².

The base paper after application is dried by heat. Examples of heat sources include a hot air dryer, an infrared heater, and a rotary dryer. In addition, regarding the drying conditions, for example, the temperature is 80 to 220° C. (preferably 100 to 200° C.) and the time is 0.1 to 180 minutes (preferably 0.5 to 60 minutes).

In the laminate obtained by the production method, a heat seal layer, a water resistant layer, an oil resistant layer or the like may be provided on the coating of the water-based composition for a barrier.

### EXAMPLES

Hereinafter, the disclosure will be described with reference to examples, but the disclosure is not limited thereto. Unless otherwise specified, “parts” and “%” in examples and comparative examples are based on weight.

### Production Example 1

38.1 parts of dimethylol butanoic acid, 314.5 parts of Polycerin DCB-2000 (polyoxytetramethylene-polyoxypropylene glycol, a number-average molecular weight of 2,000, commercially available from NOF Corporation), 128.9 parts of isophorone diisocyanate, 12.7 parts of 2-hydroxyacrylate, and 256.1 parts of stearyl methacrylate were put into a reaction container including a stirrer, a thermometer, a cooling pipe and a nitrogen gas introduction pipe, and reacted at 85° C. for 5 hours under a nitrogen gas stream, and 750.3 parts of a urethane prepolymer was obtained. Then, the urethane prepolymer was added to an aqueous solution containing 1208.0 parts of water, 225.0 parts of isopropyl alcohol, 26.6 parts of triethylamine, and 27.8 parts of adipic acid dihydrazide, and dispersed under stirring, and reacted at 50° C. for 3 hours. Next, the mixture was added to 5.0 parts of azo-type porimarization initiator (product name:“V-601”, commercially available from FUJIFILM Wako Pure Chemical Corporation), and reacted at 80° C. for 3 hours. And a predetermined amount of water was additionally added, and a urethane resin (A-1) having a non-volatile content concentration of 35%, a viscosity of 300 mPa·s, and a pH of 8.0 was obtained.

### Production Example 2

59.4 parts of dimethylol butanoic acid, 489.9 parts of PTMG1000 (polytetramethylene glycol, a number-average molecular weight of 1,000, commercially available from Mitsubishi Chemical Corporation), 275.5 parts of isophorone diisocyanate, and 2.0 parts of 2-hydroxyethyl acrylate were put into a reaction container including a stirrer, a thermometer, a cooling pipe and a nitrogen gas introduction pipe, and reacted at 85° C. for 5 hours under a nitrogen gas stream, and 826.8 parts of a urethane prepolymer was obtained. Then, the urethane prepolymer was added to and dispersed in an aqueous solution containing 1340.0 parts of water, 225.0 parts of isopropyl alcohol, 40.5 parts of triethylamine, and 43.3 parts of adipic acid dihydrazide under stirring and the mixture was reacted at 50° C. for 3 hours reaction. Next, the mixture was added to 0.1 parts of azo-type porimarization initiator (product name:“V-50”, commercially available from FUJIFILM Wako Pure Chemical Corporation), and reacted at 80° C. for 1 hours. And a predetermined amount of water was additionally added, and a urethane resin (A-2) having a non-volatile content concentration of 35%, a viscosity of 600 mPas, and a pH of 8.0 was obtained.

### Production Example 3

59.4 parts of dimethylol butanoic acid, 489.9 parts of Polycerin DCB-2000, and 200.8 parts of isophorone diisocyanate were put into a reaction container including a stirrer, a thermometer, a cooling pipe and a nitrogen gas introduction pipe, and reacted at 85° C. for 5 hours under a nitrogen gas stream, and 750.1 parts of a urethane prepolymer was obtained. Then, the urethane prepolymer was added to an aqueous solution containing 1,208 parts of water, 225 parts of isopropyl alcohol, 40.5 parts of triethylamine, and 43.3 parts of adipic acid dihydrazide, and dispersed under stirring. The mixture was reacted at 50° C. for 3 hours, a predetermined amount of water was additionally added, and a urethane resin (A-3) having a non-volatile content concentration of 35%, a viscosity of 800 mPas, and a pH of 8.0 was obtained.

### Example 1

142.9 parts of the urethane resin (A-1) (non-volatile content of 50 parts), 166.7 parts (non-volatile content of 50 parts) of a paraffin wax (product name: “Sizepine W-116H,” commercially available from Arakawa Chemical Industries, Ltd.) and 23.7 parts of deionized water were mixed to obtain a water-based composition for barrier.

### Examples 2 to 19 and Comparative Examples 1 to 6

Water-based composition for barrier were obtained in the same manner as in Example 1 except that the compositions and contents were changed as shown in Table 1.

(Production of Laminated Material (1))

Water-based composition for barrier of each Examples and Comparative Examples was applied to commercially available kraft paper (a basis weight of 70 g/m², an air impermeability of 10 seconds, and a moisture permeability of 10000 g/m² 24 h or more) with any wire bar and then dried with hot air dryer set at 120° C. for 3 minutes to obtain laminated material (1).

(Moisture Permeability)

The moisture permeability was measured according to the moisture permeability test method (cup method) of JIS Z 0208. In an atmosphere of a temperature of 40° C. and a humidity of 90%, the number of grams of water vapors that pass through per 24 hours per area 1 m² of laminate (1) (cut into a circle with a diameter of 7 cm) was measured.

TABLE 1

| | Composition of | | | | | | | |
|---|---|---|---|---|---|---|---|---|
| | water-based | | | | Additives | | Coating | Moisture |
| | composition | | | | (parts by | | amount^{※3} | permeability |
| | (parts by weight^{※1}) | | | | weight^{※2}) | | g/m² | g/m² · 24 h |
| Example 1 | A-1 | 50 | B-1 | 50 | — | | 6 | 30 |
| Example 2 | A-1 | 90 | B-1 | 10 | — | | 6 | 30 |
| Example 3 | A-1 | 40 | B-1 | 60 | — | | 9 | 50 |
| Example 4 | A-1 | 50 | B-2 | 50 | — | | 6 | 50 |
| Example 5 | A-1 | 50 | B-1 | 25 | — | | 6 | 30 |
| | | | B-2 | 25 | | | | |
| Example 6 | A-1 | 30 | B-1 | 70 | — | | 10 | 250 |
| Example 7 | A-2 | 50 | B-1 | 50 | — | | 10 | 140 |
| Example 8 | A-3 | 50 | B-1 | 50 | — | | 10 | 280 |
| Example 9 | A-1 | 50 | B-3 | 50 | — | | 10 | 100 |
| Example 10 | A-1 | 90 | B-3 | 10 | — | | 10 | 280 |
| Example 11 | A-2 | 50 | B-3 | 50 | — | | 10 | 80 |
| Example 12 | A-2 | 70 | B-3 | 30 | — | | 10 | 70 |
| Example 13 | A-2 | 90 | B-3 | 10 | — | | 10 | 100 |
| Example 14 | A-3 | 50 | B-3 | 50 | — | | 10 | 70 |
| Example 15 | A-3 | 90 | B-3 | 10 | — | | 10 | 60 |
| Example 16 | A-3 | 50 | B-1 | 25 | — | | 10 | 30 |
| | | | B-3 | 25 | | | | |
| Example 17 | A-1 | 90 | B-1 | 10 | E-1 | 10 | 6 | 40 |
| Example 18 | A-1 | 90 | B-1 | 10 | E-2 | 10 | 6 | 40 |
| Example 19 | A-1 | 90 | B-1 | 10 | E-3 | 10 | 6 | 30 |

| | | | | | | | |
|---|---|---|---|---|---|---|---|
| Comparative | C-1 | 50 | B-1 | 50 | — | 10 | 3800 |
| Example 1 | | | | | | | |
| Comparative | A-1 | 50 | D-1 | 50 | — | 10 | 1400 |
| Example 2 | | | | | | | |
| Comparative | A-1 | 50 | D-2 | 50 | — | 10 | 800 |
| Example 3 | | | | | | | |
| Comparative | A-1 | 20 | B-1 | 80 | — | 10 | 600 |
| Example 4 | | | | | | | |

| | | | | | | |
|---|---|---|---|---|---|---|
| Comparative | A-1 | 100 | — | — | 10 | 2000 |
| Example 5 | | | | | | |

| | | | | | | |
|---|---|---|---|---|---|---|
| Comparative | — | B-1 | 100 | — | 10 | 2000 |
| Example 6 | | | | | | |

*1: The parts by weight of component (A) and component (B) are expressed by the weight of the non-volatile
*2: The parts by weight of an additive is expressed by the weight of the non-volatile with respect to the total of 100 parts by weight (non-volatile content) of the component (A) and the component (B)
*3: The coating amount is expressed as a value in terms of non-volatile content.

The symbols in Table 1 indicate the following compounds.

### (Resins)

A-1: urethane resin of Production Example 1
A-2: urethane resin of Production Example 2
A-3: urethane resin of Production Example 3
C-1: olefin resin (product name: “Polymaron 482S,” commercially available from Arakawa Chemical Industries, Ltd.)

### (Wax)

B-1: paraffin wax (product name: “Sizepine W-116H,” commercially available from Arakawa Chemical Industries, Ltd.)
B-2: Carnauba wax (product name: “EMUSTAR-0413,” commercially available from Nippon Seiro Industries, Ltd.)
B-3: AKD emulsion (product name: “Sizepine K-924,” commercially available from Arakawa Chemical Industries, Ltd., Emulsion)
D-1: polyethylene wax (product name: “Chemipearl W401,” commercially available from Mitsui Chemicals, Inc., Emulsion)
D-2: fatty acid emulsion (product name: “Sizepine CA-956,” commercially available from Arakawa Chemical Industries, Ltd., Emulsion)

### (Additives)

E-1: saponified rosin (product name: “Sizepine E,” commercially available from Arakawa Chemical Industries, Ltd., Aqueous solution)
E-2: Rosin resin (product name: “Sizepine N-817,” commercially available from Arakawa Chemical Industries, Ltd., Emulsion)
E-3: Carbodiimide curing agent (product name: “CARBODILITE SV-02,” commercially available from Nisshinnbo Chemical Inc., Aqueous solution)

(Production of Laminated Material (2))

A water-based composition for barrier of Example 1 was applied to commercially available processed base paper (a basis weight of 50 g/m², an air impermeability of 90 seconds, and a moisture permeability of 10000 g/m² 24 h or more) with any wire bar and then dried with hot air dryer set at 120° C. for 3 minutes to obtain laminated material (2) having a coating amount of 5 g/m². When the moisture permeability was measured in the same manner as in the previous paragraph, it showed a good barrier property of 30 g/m²24 h.

(Production of Laminated Material (3))

A water-based composition for barrier of Example 1 was applied to commercially available polyethylene terephthalate film (product name: “COSMOSHINE A4100,” a thickness of 50 m, and a moisture permeability of 13 g/m²·24 h, commercially available from Toyobo Co., Ltd.) with any wire bar and then dried with hot air dryer set at 120° C. for 3 minutes to obtain laminated material (3) having a coating amount of 5 g/m². When the moisture permeability was measured in the same manner as in the previous paragraph, it showed a good barrier property of 4 g/m²24 h.

(Production of Laminated Material (4))

A water-based composition for barrier of Example 12 was applied to commercially available triacetylcellulose film (product name: “FT TD80 ULM,” a thickness of 80 m, and a moisture permeability of 330 g/m² 24 h, commercially available from FUJIFILM Corporation) with any wire bar and then dried with hot air dryer set at 170° C. for 3 minutes to obtain laminated material (4) having a coating amount of 5 g/m². When the moisture permeability was measured in the same manner as in the previous paragraph, it showed a good barrier property of 4 g/m²·24 h.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A water-based composition for barrier, comprising a urethane resin (A) which is comprising a polyol (a1), a polyisocyanate (a2) and a chain extender (a3) as essential reaction components, and at least one wax (B) selected from the group consisting of a paraffin, a carnauba and an alkyl ketene dimer,
wherein a content ratio between the component (A) and the component (B) in terms of the non-volatile content weight is (A)/(B)=25/75 to 95/5.

2. The water-based composition for barrier according to claim 1, wherein the component (a1) comprises a polyether polyol.

3. The water-based composition for barrier according to claim 1, wherein the component (a3) comprises a dialkanol alkanoic acid.

4. The water-based composition for barrier according to claim 1, wherein the reaction components further comprise a hydroxy alkyl (meth)acrylic acid ester (a4).

5. The water-based composition for barrier according to claim 1, wherein the reaction components further comprise a (meth)acrylic acid alkyl ester having no hydroxyl group (a5).

6. The water-based composition for barrier according to claim 1, further comprises a rosin-based resin and/or a curing agent.

7. A laminated material having a coating layer of the water-based composition for barrier according to claim 1 on at least one surface of a substrate.
